(19) United States
(12) Patent Application Publication
(10) Pub. No.: US 2025/0246663 A1
(43) Pub. Date: Jul. 31, 2025

(54) STACKING APPARATUS

(71) Applicant: HONDA MOTOR CO., LTD., Tokyo (JP)

(72) Inventors: Ryo TAKANO, Saitama (JP); Takeshi OHORI, Saitama (JP)

(21) Appl. No.: 19/033,489

(22) Filed: Jan. 22, 2025

(30) Foreign Application Priority Data
Jan. 29, 2024 (JP) 2024-011034

(51) Int. Cl. H01M 8/2404

(52) U.S. Cl. CPC H01M 8/2404

(57) ABSTRACT

Provided is a stacking apparatus that can improve energy efficiency when stacking fuel cells, by improving efficiency in positioning and holding the fuel cells. A stacking apparatus 1 includes: a meter 40 disposed above a stacking surface P that is the upper surface of the uppermost one of the fuel cells FC to form a stack, the meter 40 being capable of measuring a height of the stacking surface P in a non-contact manner without contacting with the stacking surface P; a calculator 90 configured to calculate an elevation amount for maintaining the height of the stacking surface P measured by the meter 40 at a predetermined height; and an adjuster 20 configured to adjust the height of the stacking surface P based on the elevation amount calculated by the calculator 90.

This application is based on and claims the benefit of priority from Japanese Patent Application No. 2024-011034, filed on 29 Jan. 2024, the content of which is incorporated herein by reference.

### BACKGROUND OF THE INVENTION

### Field of the Invention

The present invention relates to a stacking apparatus.

### Related Art

There is a known stacking apparatus that positions and stacks a plurality of fuel cells for constituting a fuel cell stack (see Japanese Unexamined Patent Application, Publication No. 2016-157521).
Patent Document 1: Japanese Unexamined Patent Application, Publication No. 2016-157521

### SUMMARY OF THE INVENTION

The above-described stacking apparatus has to be configured such that a cell posture changer is disposed in an upper portion of the stacking apparatus, whereby the degree of freedom in designing the apparatus configuration is limited. An object of the present invention is to provide a stacking apparatus that allows a high degree of freedom in designing the apparatus configuration and that is capable of improving energy efficiency.

To achieve the above object, the present invention provides a stacking apparatus (e.g., a stacking apparatus 1 to be described later) for stacking a plurality of fuel cells (e.g., fuel cells FC to be described later), the stacking apparatus including: a meter (e.g., a meter 40 to be described later) disposed above a stacking surface (e.g., a stacking surface P to be described later) that is an upper surface of an uppermost one of the fuel cells to form a stack, the meter being capable of measuring a height of the stacking surface in a non-contact manner without contacting with the stacking surface; a calculator (e.g., a controller 90 to be described later) configured to calculate an elevation amount for maintaining the height of the stacking surface measured by the meter at a predetermined height; and an adjuster (e.g., an adjuster 20 to be described later) configured to adjust the height of the stacking surface based on the elevation amount calculated by the calculator.

According to the invention, it is preferable that the plurality of fuel cells are stacked by being guided and positioned by a positioning bar (e.g., a positioning bar 71 to be described later), and the meter measures the height of the stacking surface at a portion (e.g., a portion R to be described later) in a vicinity of a section of the uppermost one of the fuel cells, the section being positioned by the positioning bar.

It is preferable that the adjuster includes a servomotor, and the height of the stacking surface is adjusted by driving the servomotor.

The present invention provides a stacking apparatus that allows a high degree of freedom in designing the apparatus configuration and that is capable of improving energy efficiency.

### BRIEF DESCRIPTION OF THE DRAWINGS

FIG. 1 is a diagram illustrating a stacking apparatus according to an embodiment;

FIG. 2 is a diagram illustrating an initial stage and a middle stage of a process of stacking fuel cells by the stacking apparatus according to the embodiment; and

FIG. 3 is a flowchart illustrating control performed by a controller of the stacking apparatus according to the embodiment.

### DETAILED DESCRIPTION OF THE INVENTION

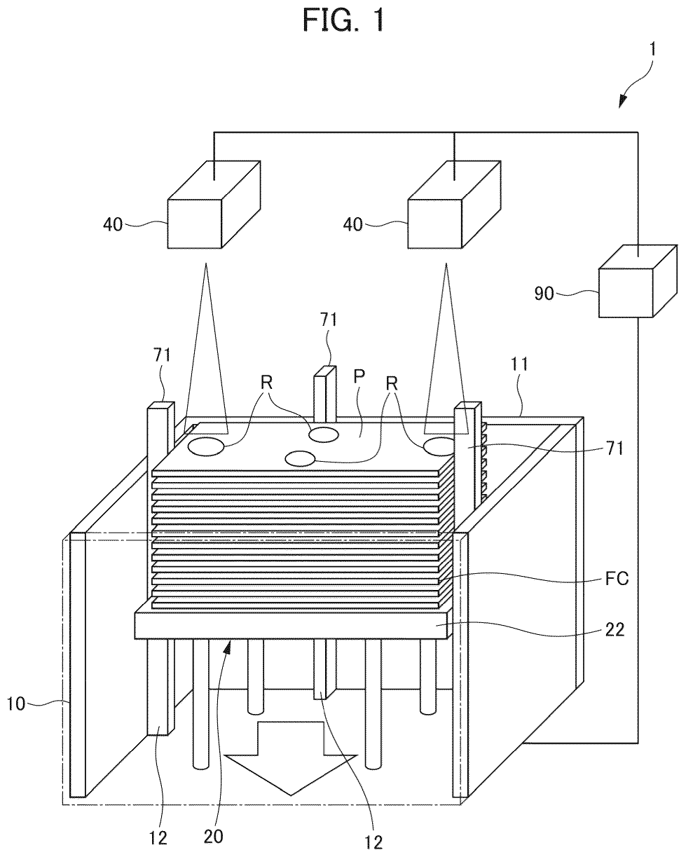

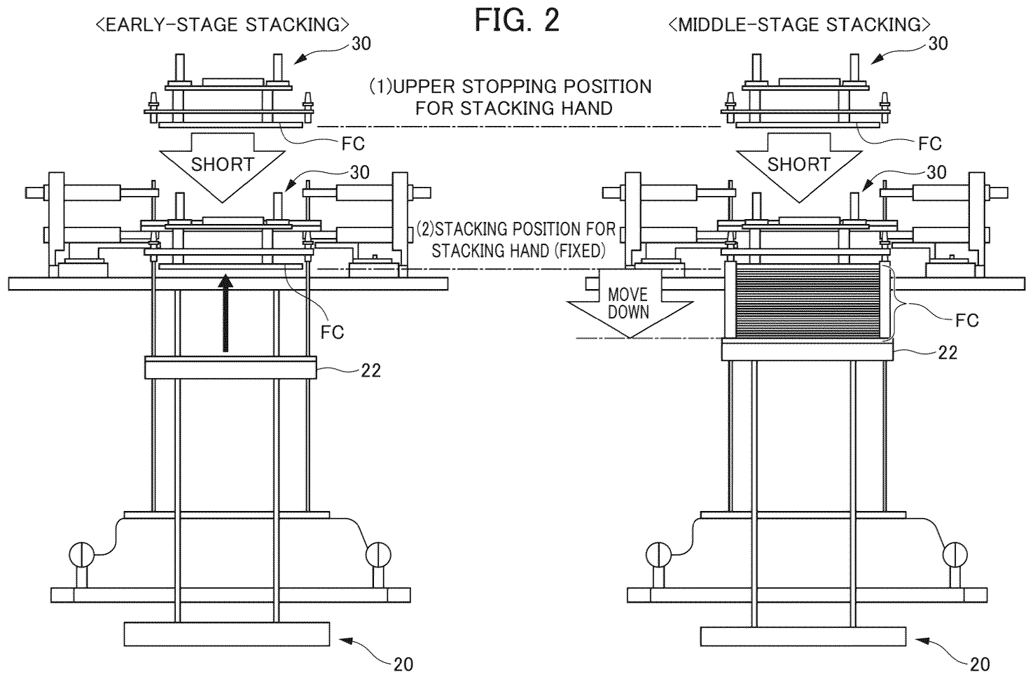

An embodiment of the present invention will be described below. As illustrated in FIGS. 1 and 2, etc., a stacking apparatus 1 is for stacking a plurality of fuel cells FC, and includes a stack case 10, an adjuster 20, a stacking hand 30 (see FIG. 2, etc.), meters 40, and a controller 90.

The stack case 10 has a rectangular parallelepiped box shape having an upper opening 11 in place of the entire upper surface. Inside the stack case 10, a plate-shaped pin lifter 22 that forms part of the adjuster 20 is disposed horizontally. The fuel cells FC can be placed on the upper surface of the pin lifter 22. The plurality of rectangular plate-shaped fuel cells FC are each inserted through the upper opening 11 into the stack case 10 while being supported horizontally, whereby the plurality of fuel cells FC are stacked inside the stack case 10.

The pin lifter 22 is connected to a servomotor that forms part of the adjuster 20, which is provided in a lower portion of the stack case 10 (see FIG. 2, etc.). Driving the servomotor allows the pin lifter 22 to move in the vertical direction in the stack case 10. The adjuster 20 adjusts the height of a stacking surface P, which is the upper surface of the uppermost one of the fuel cells FC to form a stack, based on an elevation amount calculated by a calculator of the controller 90.

The stack case 10 includes case interior bars 12 provided therein. The case interior bars 12 are respectively disposed adjacent to the four side walls of the rectangular parallelepiped stack case 10 such that each case interior bar 12 is positioned at a center portion in the horizontal direction of the side wall while the longitudinal direction of the case interior bar 12 is along the vertical direction. For the purpose of illustration, FIG. 1 does not show the side wall close to the viewer, from among the four side walls of the rectangular parallelepiped stack case 10.

Each rectangular fuel cell FC has indents serving as engagement portions and respectively formed on the four sides of the fuel cell FC. The case interior bars 12 guide the vertical movement of each fuel cell FC inserted into the stack case 10 and position the fuel cell FC in the stack case 10, while engaging with the indents of the fuel cell FC.

A rectangular plate-shaped bar holder (not shown) that covers the upper opening 11 of the stack case 10 from above is fixed to the stack case 10, and positioning bars 71 (see FIG. 1) are detachably attached to the bar holder. The positioning bars 71 are fixed while having their lower end surfaces facing the upper end surface of the case interior bars 12 so as to form upward extensions of the case interior bars 12, and are fixed to and held by the bar holder (not shown). The fuel cells FC are guided and positioned by the positioning bars 71, moved to the case interior bars 12, guided by the case interior bars 12, and stacked on the pin lifter 22 in the stack case 10.

The stacking hand 30 conveys the fuel cell FC while supporting it horizontally. The stacking hand 30 then inserts the conveyed fuel cell FC into the stack case 10 through the upper opening 11 while maintaining it horizontal. Thus, the stacking hand 30 is configured to stack the fuel cells FC one by one on the pin lifter 22 in the stack case 10.

The meters 40 each include a distance sensor having a laser irradiator. The distance sensor can measure the height of the stacking surface P, which is the upper surface of the uppermost one of the fuel cells FC to form a stack, in a non-contact manner without contacting with the stacking surface P. Specifically, the distance sensor is configured to detect a distance between the laser irradiator and the stacking surface P by irradiating the stacking surface P with a laser beam and receiving a reflected laser beam, and output the height of the stacking surface P. The laser irradiator may emit any type of laser beam, but in the present embodiment, an infrared laser beam is used, for example.

The meters 40 include four meters 40. FIG. 1 illustrates only two meters 40 for convenience of description. As illustrated in FIG. 1, the four meters 40 are disposed directly above the stacking surface P, which is the upper surface of the uppermost one of the fuel cells FC to form a stack. The meters 40 are configured to measure the height of the stacking surface P at portions R in the vicinities of sections of the uppermost fuel cell FC that are in contact with and positioned by the four positioning bars 71, and output the measured values.

The controller 90 constitutes a calculator and includes, for example, a central processing unit (CPU), storage media such as a volatile memory, a nonvolatile memory, and the like. The controller 90 is electrically connected to the servomotor of the adjuster 20, the distance sensors of the meters 40, and the like, receives an input of signals outputted from the distance sensors of the meters 40, and outputs a signal for driving the servomotor of the adjuster 20 to the servomotor.

The controller 90 receives an input of signals including height values of the stacking surface P and outputted from the distance sensors of the meters 40, and calculates an elevation amount for maintaining the height of the stacking surface P at a predetermined height. Specifically, in response to an input of the signals including the height values of the stacking surface P from the four meters 40, the controller 90 calculates an average value of the height values. The controller 90 then calculates, as the elevation amount, a difference between the predetermined height and the average value. That is, the elevation amount means an amount by which the pin lifter 22 is moved in the vertical direction to make the height of the stacking surface P equal to the predetermined height when the stacking surface P is at a height position different from a predetermined position.

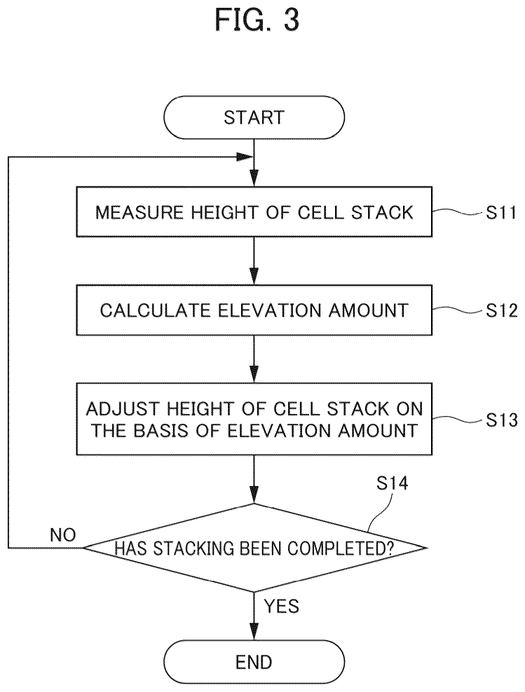

Next, control that the controller 90 performs to move the pin lifter 22 in the vertical direction will be described with reference to the flowchart illustrated in FIG. 3. First, in Step S11, the controller 90 controls and causes the distance sensors of the four meters 40 to measure the height of the stacking surface P. Then, the control by the controller 90 proceeds to Step S12.

Next, in Step S12, the controller 90 receives an input of four height values indicating the heights of the four portions R of the stacking surface P and outputted from the four meters 40, and then, calculates an average value of the four values. Subsequently, the controller 90 calculates a difference between a predetermined value and the average value, and sets the difference as an elevation amount. The control by the controller 90 then proceeds to Step S13.

Next, in Step S13, the controller 90 controls the servomotor of the adjuster 20 to adjust the position of the pin lifter 22 based on the elevation amount such that the height value of the stacking surface P becomes equal to a predetermined value.

Specifically, in a case where the average height value of the stacking surface P is greater than the predetermined value (see “MIDDLE STAGE OF STACKING PROCESS” in FIG. 2), the controller 90 drives and controls the servomotor of the adjuster 20 to lower the pin lifter 22 by the elevation amount. In a case where the average height value of the stacking surface P is less than the predetermined value (see “INITIAL STAGE OF STACKING PROCESS” in FIG. 2), the controller 90 drives and controls the servomotor of the adjuster 20 to raise the pin lifter 22 by the elevation amount. As a result, the average height value of the stacking surface P becomes equal to the predetermined value. Then, the control by the controller 90 proceeds to Step S14.

Next, in Step S14, the controller 90 determines whether or not stacking of the fuel cells FC has been completed, that is, whether or not stacking of a predetermined number of fuel cells FC has been completed. When the stacking of the fuel cells FC has been completed (YES in Step S14), the control by the controller 90 ends.

When the stacking of the fuel cells FC is not completed (NO in Step S14), the controller 90 controls and causes the stacking hand 30 to newly convey one fuel cell FC and insert the one fuel cell FC through the upper opening 11 into the stack case 10 while maintaining it horizontal. Subsequently, the controller 90 controls and causes the stacking hand 30 to place the one fuel cell FC on the uppermost one of the fuel cells FC stacked on the pin lifter 22 in the stack case 10. Then, the control by the controller 90 returns to Step S11, and the above-described process is performed every time one fuel cell FC is stacked.

The embodiment described above exerts the following effects. A stacking apparatus 1 of the present embodiment includes: meters 40 disposed above a stacking surface P that is the upper surface of the uppermost one of the fuel cells FC to form a stack, the meters 40 being capable of measuring the height of the stacking surface P in a non-contact manner without contacting with the stacking surface P; a controller 90 including a calculator that calculates an elevation amount for maintaining the height of the stacking surface P measured by the meters 40 at a predetermined height; and an adjuster 20 that adjusts the height of the stacking surface P based on the elevation amount calculated by the calculator of the controller 90.

In the case of stacking the fuel cells FC at a high speed, it is necessary to cause the stacking hand 30 to move in the vertical direction by a constant short distance as indicated by “SHORT” in the arrows in FIG. 2, by maintaining the height of the stacking surface P at the predetermined position. However, the fuel cells FC have spring properties (and are likely to warp and undulate), and the thickness changes significantly as the number of stacked fuel cells FC increases.

When the height of the stacking surface P becomes too high for the above reason, the stacking surface P is positioned above the upper ends of the positioning bars 71, whereby the positioning performance deteriorates. When the height of the stacking surface P becomes too low, bar-cell locking takes place: when a fuel cell FC is dropped to be stacked, the fuel cell FC cannot be maintained horizontal and is inclined, resulting in the fuel cell FC not being stacked properly but being inclined. In addition, in a case where the fuel cells FC are conveyed to the stacking surface P at different heights, the conveyance distance may increase, which leads to an increase in the conveyance time.

In contrast, in the present embodiment, the height of the stacking surface P is fed back to the elevation amount, thereby allowing the adjuster 20 to adjust and maintain the height of the stacking surface P at the predetermined position, and in this state, the next one fuel cell FC can be stacked. This makes it possible to reduce the distance by which the stacking hand 30 moves each fuel cell FC in the vertical direction when conveying the fuel cell FC, thereby enabling an automated process in which the stacking hand 30 stacks the fuel cells FC at a high speed.

Furthermore, in the present embodiment, the plurality of fuel cells FC are stacked by being guided and positioned by positioning bars 71, and the meters 40 measure the height of the stacking surface P at portions R in the vicinities of sections of the uppermost fuel cell FC that are positioned by the positioning bars 71. This feature makes it possible to reduce the likelihood of significant variation of the measured values.

Furthermore, in the present embodiment, the adjuster 20 includes a servomotor, and the height of the stacking surface P is adjusted by driving the servomotor. Due to this feature, the height of the stacking surface P can be adjusted with high accuracy by minute rotation of the servomotor.

It should be noted that the present invention is not limited to the above-described embodiment, but encompasses modifications, improvements, and the like within a range in which the object of the present invention can be achieved. For example, the number and positions of the meters 40 are not limited to those in the embodiment described above. Moreover, although the adjuster 20 includes a servomotor, the present invention is not limited thereto, and a different type of motor or the like may be used.

### EXPLANATION OF REFERENCE NUMERALS

1: Stacking apparatus
20: Adjuster
40: Meter
71: Positioning bar
90: Controller (Calculator)
FC: Fuel cell
P: Stacking surface
R: Portion

What is claimed is:

1. A stacking apparatus for stacking a plurality of fuel cells, the stacking apparatus comprising:
a meter disposed above a stacking surface that is an upper surface of an uppermost one of the fuel cells to form a stack, the meter being capable of measuring a height of the stacking surface in a non-contact manner without contacting with the stacking surface;
a calculator configured to calculate an elevation amount for maintaining the height of the stacking surface measured by the meter at a predetermined height; and
an adjuster configured to adjust the height of the stacking surface based on the elevation amount calculated by the calculator.

2. The stacking apparatus according to claim 1, further comprising a positioning bar, wherein
the plurality of fuel cells are stacked by being guided and positioned by the positioning bar, and
the meter measures the height of the stacking surface at a portion in a vicinity of a section of the uppermost one of the fuel cells, the section being positioned by the positioning bar.

3. The stacking apparatus according to claim 1, wherein
the adjuster comprises a servomotor, and
the height of the stacking surface is adjusted by driving the servomotor.
